(19) United States
(12) Patent Application Publication
(10) Pub. No.: US 2019/0337075 A1
(43) Pub. Date: Nov. 7, 2019

(54) SYSTEMS AND DEVICES FOR IMPROVED SOLDER DISPENSING

(71) Applicant: Artos Engineering Company, Brookfield, WI (US)

(72) Inventor: Michael A. Kirst, Pewaukee, WI (US)

(73) Assignee: Artos Engineering Company, Brookfield, WI (US)

(21) Appl. No.: 15/968,141

(22) Filed: May 1, 2018

(51) Int. Cl. B23K 3/06; B23K 1/08

(52) U.S. Cl. CPC B23K 3/0653; B23K 1/085

(57) ABSTRACT

Systems and methods for soldering a workpiece using a solder application system. A nozzle includes a plurality of walls and a floor that together define a nozzle reservoir for containing liquid solder. The plurality of walls also define a soldering region that is external to the nozzle reservoir. The plurality of walls in the soldering region define holes that are configured to dispense the liquid solder from the nozzle reservoir. The holes are configured such that the liquid solder dispensed therefrom merges into a combined stream and the workpiece is soldered when placed into the combined stream

### FIELD

The present disclosure generally relates to systems and devise for dispensing solder, and particularly to systems and devices for dispensing solder evenly.

### BACKGROUND

The Background and Summary are provided to introduce a foundation and selection of concepts that are further described below in the Detailed Description. The Background and Summary are not intended to identify key or essential features of the claimed subject matter, nor are they intended to be used as an aid in limiting the scope of the claimed subject matter.

Solder application systems are generally known in the art for providing a flow of liquid solder for soldering a workpiece, such as a wire. An exemplary solder application system is manufactured by Artos Engineering Company of Brookfield, Wisconsin, known as Solder Pot SD-1. The solder application system heats solder to a liquid state in a solder pot, at which point a pumping system pumps the liquid solder up to a nozzle. The nozzle has an opening in the floor that allows the liquid solder to drain out as a downward, vertical stream. The workpiece is then soldered by inserting it into the flow of liquid solder draining downwardly from the nozzle.

### SUMMARY

One embodiment of the present disclosure generally relates to a nozzle for soldering a workpiece using a solder application system. The nozzle includes a plurality of walls and a floor that together define a nozzle reservoir for containing liquid solder. The plurality of walls also define a soldering region that is external to the nozzle reservoir. The plurality of walls in the soldering region define holes that are configured to dispense the liquid solder from the nozzle reservoir. The nozzle is configured such that the workpiece is soldered when placed into the soldering region.

Another embodiment generally relates to a method for making a nozzle for soldering a workpiece using a solder application system. The method includes arranging a plurality of walls and a floor to together define a nozzle reservoir for containing liquid solder from the solder application system. The plurality of walls also define a soldering region that is external to the nozzle reservoir and is configured to receive the workpiece. The method further includes defining holes within the plurality of walls in the soldering region, where the holes are configured to dispense the liquid solder from the nozzle reservoir. The nozzle is configured such that the workpiece is soldered when placed in the soldering region.

Another embodiment generally relates to a solder application system for soldering a workpiece. The solder application system includes a solder pot for containing liquid solder and a nozzle configured to dispense the liquid solder for soldering the workpiece. The nozzle includes a plurality of walls and a floor that together define a nozzle reservoir for containing the liquid solder to be dispensed. The plurality of walls also define a soldering region that is external to the nozzle reservoir and the plurality of walls within the soldering region define holes configured to dispense the liquid solder from the nozzle reservoir. The solder pot system further includes a pumping system for pumping the liquid solder from the solder pot to the nozzle reservoir. The holes are configured such that the liquid solder dispensed therefrom merges into a combined stream such that the workpiece is soldered when placed into the combined stream.

Various other features, objects and advantages of the disclosure will be made apparent from the following description taken together with the drawings.

### BRIEF DESCRIPTION OF THE DRAWINGS

The drawings illustrate the best mode presently contemplated of carrying out the disclosure. The same numbers are used throughout the drawings to reference like features and like components. In the drawings:

FIG. 1 is a perspective view of a solder application system known in the art.

FIG. 2 is a close up view taken along the line 2-2 of FIG. 1, showing liquid solder draining downwardly from the nozzle.

FIGS. 3 and 4 depict side and front views taken along the lines 3-3 and 4-4 of FIG. 2, respectively.

FIG. 5 is a perspective view of a solder application system and nozzle in accordance with the present disclosure.

FIG. 6 is a close up view of the nozzle shown in FIG. 5 taken along line 6-6, showing solder being dispensed outwardly from the nozzle.

FIGS. 7 and 8 depict side and front views taken along the lines 7-7 and 8-8 of FIG. 6, respectively.

FIGS. 9-10 are perspective views of additional embodiments of nozzles in accordance with the present disclosure.

### DETAILED DISCLOSURE

This written description uses examples to disclose embodiments of the present application, including the best mode, and also to enable any person skilled in the art to practice or make and use the same. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

Solder application systems are generally known in the art for dispensing a stream of liquid solder that can be used for soldering a workpiece, such as a wire. While reference will generally be made to a wire, the present disclosure anticipates applications with any type of workpiece to be soldered.

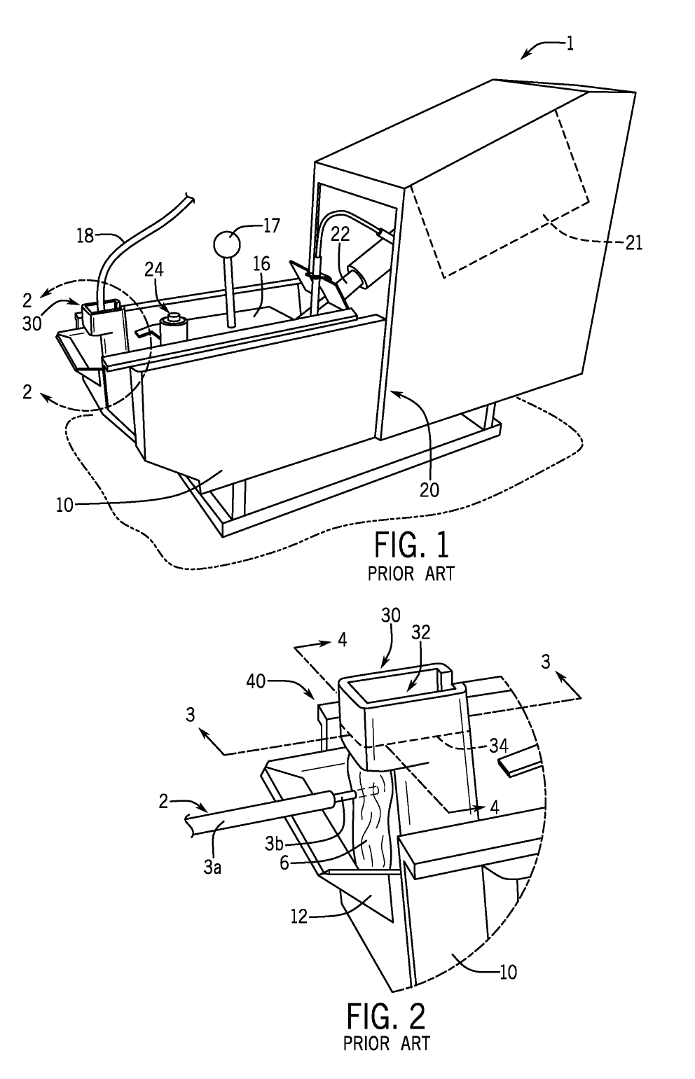

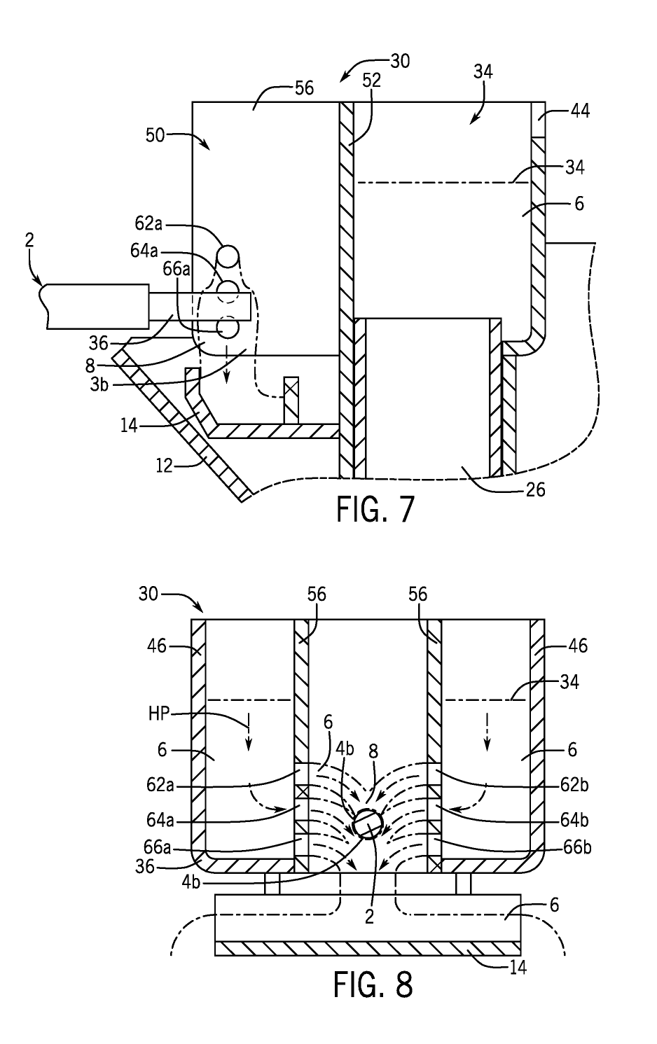

As shown in FIGS. 1 and 2, a conventional solder application system includes a pumping system 20 that pumps the liquid solder 6 up from the solder pot 10 to the nozzle 30 via pipe 26 (see also FIG. 7). A nozzle reservoir 32 within the nozzle 30 contains the liquid solder 6 to be dispensed, which as shown in FIG. 2 produces a vertical flow of liquid solder 6 as it drains from an opening 38 in the floor 36 of the nozzle 30. Providing a vertical flow of liquid solder 6 allows a workpiece, such as a wire 2, to be horizontally presented to the flow. This configuration is advantageous for wire producing machines since wire processing typically occurs in a horizontal plane.

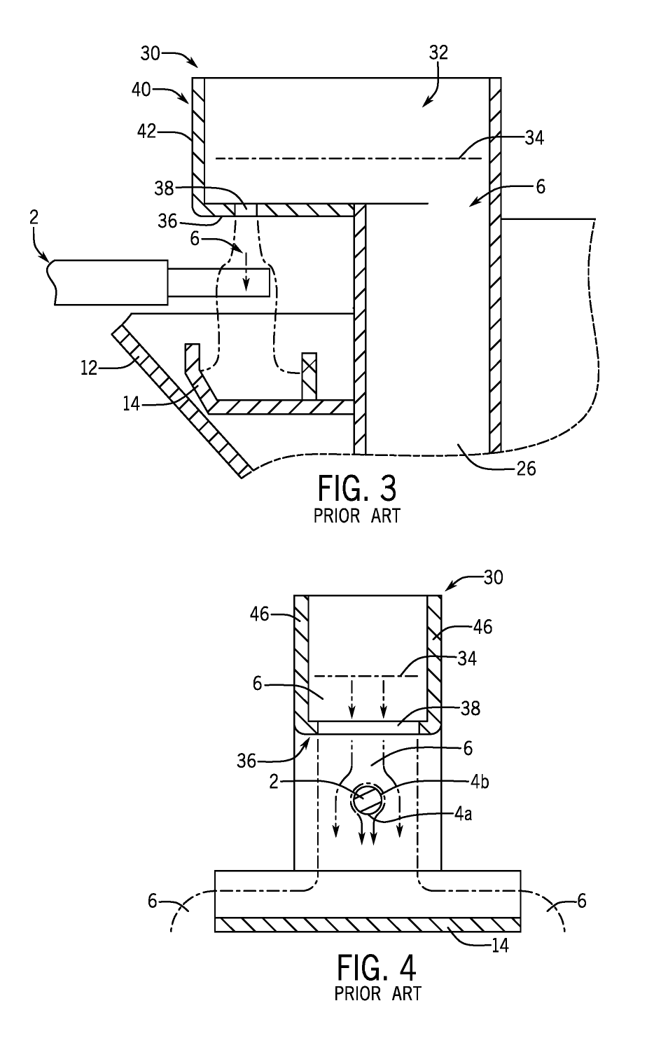

As shown in FIG. 2, the stripped portion 3b of a wire 2 is inserted into the flow of liquid solder 6 to thereby be soldered, and withdrawn once complete. Any surplus of the liquid solder 6 that is not deposited on (or soldered to) the workpiece is first collected in a solder deflector 14 (FIG. 3) provided within the spillway 12, which redirects the liquid solder 6 to the solder pot 10 to be pumped by the pumping system 20 once again. Alternatively, the liquid solder not deposited on the workpiece could simply fall back into the solder pot 10 if the system does not include a deflector 14.

The pumping system 20 includes a motor 21 coupled to a pump shaft 22 that rotates to drive an impeller pump 24 positioned beneath the cover 16, which pumps the liquid solder 6 from the solder pot 10 to the nozzle 30 in the matter known in the art. A flow sensor 18 is positioned within the nozzle reservoir 32 to provide feedback to the pumping system 20 to either pump more of the liquid solder 6 from the solder pot 10 to the nozzle reservoir 32, or to stop pumping once the nozzle reservoir 32 has been filled to a pre-established fill height 34.

The present inventors have identified that, in use, solder application systems known in the art provide inadequate soldering for workpieces based on issues with the stream of liquid solder dispensed by presently known nozzles. As demonstrated in FIG. 4, when inserting a wire 2 into the vertical flow of liquid solder 6 dispensed from the nozzle 30, the top and sides of the wire 2 are covered with solder (shown as soldered portion 4b). However, the underside of the wire 2 is shadowed by the wire 2 itself such that the liquid solder 6 is deflected and does not solder the underside of the wire 2 (non-soldered portion 4a). In practice, it is desirable for the wire 2 to be completely soldered on all sides, as well as being soldered throughout when the wire 2 is of a stranded form. In this regard, the present inventors have identified that the solder application systems 1 presently known in the art necessarily rely upon a wicking action for wires 2 to draw the liquid solder 6 in from the top and sides to also provide solder for the underside of the wire 2 (and throughout the wire 2 for wire 2 in stranded form).

Through experimentation and development, the present inventors have also identified that this wicking action is unreliable and inconsistent, often resulting in a wire 2 that is not soldered on all sides, nor throughout. This can be further exacerbated by the particular material of the wire 2, the type of flux being used, and the size of the wire 2. Moreover, the present inventors have identified that in the cases of soldering a wire 2 that is solid, or includes braiding around a coax cable, liquid solder 6 in fact cannot go through the wire 2 and, therefore, no such wicking is even possible. In these cases, the underside of the wire 2 is frequently not soldered, constituting a defect and a failure of the solder application system 1.

The present inventors have recognized that repositioning the wire 2 to be dipped downwardly into a solder pot 10 of standing liquid solder 6 is one way to solder the wire 2 consistently on all sides and throughout. However, wire production typically occurs on a horizontal plane. As such, the present inventors have recognized that this step of repositioning the wire 2 substantially slows down the wire 2 production process by requiring the wire 2 to be bent or rotated at a right angle in order to be dipped. This additional step also adds complication and cost to the price-sensitive production process.

The systems and devices of the present disclosure improve upon these limitations and failures of the prior art, providing consistent and complete soldering around all sides of a wire 2. As will be discussed further below, this is generally accomplished by providing multiple streams of liquid solder 6 with the nozzle 30, while still allowing a wire to be inserted horizontally. Liquid solder 6 is thereby distributed on all sides of the wire 2 by virtue of the wire 2 being placed into the center of the streams. In particular, soldering occurs on all sides of the wire 2 due to the horizontal flow of liquid solder 6 being directed towards the sides of the wire 2, as well as from added turbulence provided to the combined stream 8 of liquid solder 6 streams merged together after being dispensed from the nozzle.

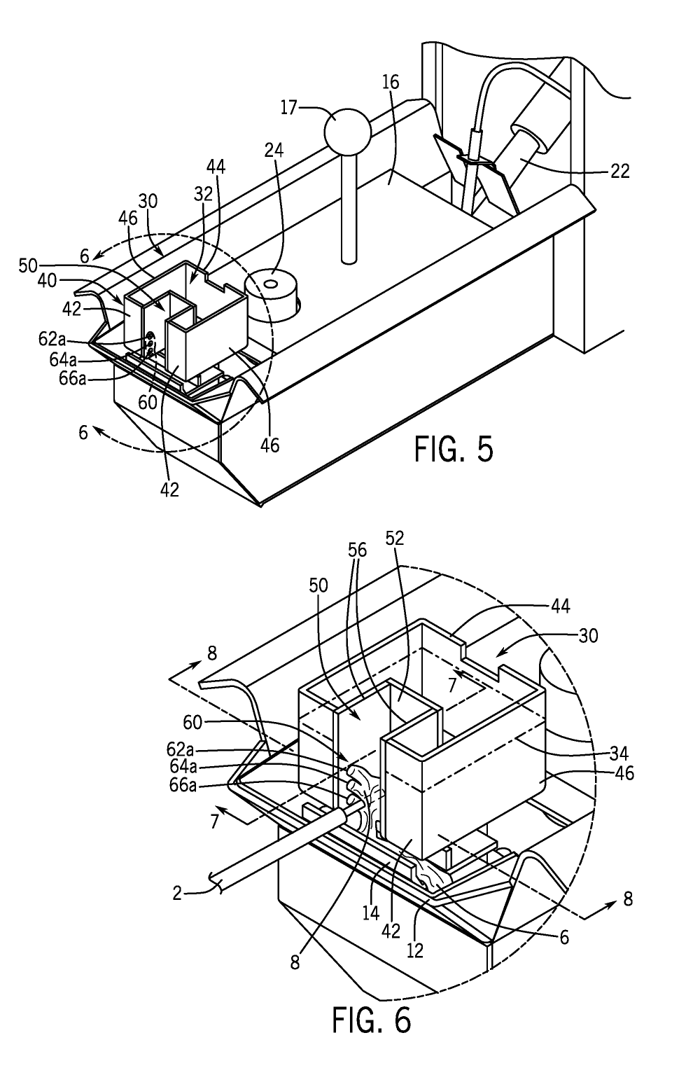

Consistent with solder application systems 1 known in the art, the exemplary embodiments shown in FIGS. 5-10 include a pumping system 20 that fills the nozzle reservoir 32 to a fill height 34 with liquid solder 6 drawn up from the solder pot 10. In the embodiment shown, the fill height 34 is higher than the holes 60 in the nozzle 30 such that head pressure HP is generated and thus causes the liquid solder 6 to squirt out of each of the holes 60 in a horizontal stream. In this regard, the presently shown system generates pressure as a gravity fed system. However, other embodiments use the pumping system 20 or another pump to replace or supplement the pressure provided by gravity for dispensing the liquid solder 6 out of the holes 60. For example, the embodiment of FIG. 10 includes a cover 39 over the nozzle reservoir 32 such that the liquid solder 6 in the nozzle 30 is pressurized by the pumping system 20. The cover 39 may also reduce or slow the production of dress, which is further beneficial in maintaining an efficient operation and minimizing clean efforts.

Certain embodiment of the present disclosure relate to a nozzle 30 for soldering a workpiece using a solder application system 1, as shown in FIGS. 5-10. The nozzle 30 includes walls 40 and a floor 36 that together define a nozzle reservoir 32 for containing liquid solder 6. The walls 40 further define a soldering region 50 that is external to the nozzle reservoir 32, shown here to be a substantially square or rectangular shape that is recessed within a nozzle reservoir 32. This results in the nozzle reservoir 32 having a U-shape, rather than the square or rectangular shape of nozzles 30 known in the art. Other shapes and configurations of the nozzle reservoir 32 are also anticipated by the present disclosure. As shown in FIGS. 5 and 6, the walls 40 within the soldering region 50 define holes 60 that are configured to dispense the liquid solder 6 from the nozzle reservoir 32.

In certain embodiment, the holes 60 are configured such that the liquid solder 6 being dispensed from the holes 60 merge to form a combined stream 8 within the soldering region 50. As shown in FIGS. 6 and 8, in certain embodiments the holes 60 are opposing holes arranged as two columns of three holes, whereby the liquid solder 6 is dispensed from the holes 60 in a substantially horizontal direction. The liquid solder 6 dispensed by the holes 60 meet, in part due to the force of gravity, to form a combined stream 8 directed downwardly near the center of the soldering region 50. In other embodiments, the liquid solder 6 dispensed from the holes 60 does not merge into a combined stream, but remains as separate streams.

FIGS. 6 and 8 show an embodiment having 3 pairs of opposing holes as the holes 60. Specifically, these opposing holes include upper holes 62a and 62b, middle holes 64a and 64b, and lower holes 66a and 66b that are defined within opposing sides of the internal side faces 56. Thus, these pairs or sets of upper holes 62a and 62b, middle holes 64a and 64b, and lower holes 66a and 66b are sometimes referred to as pairs or sets of opposing holes.

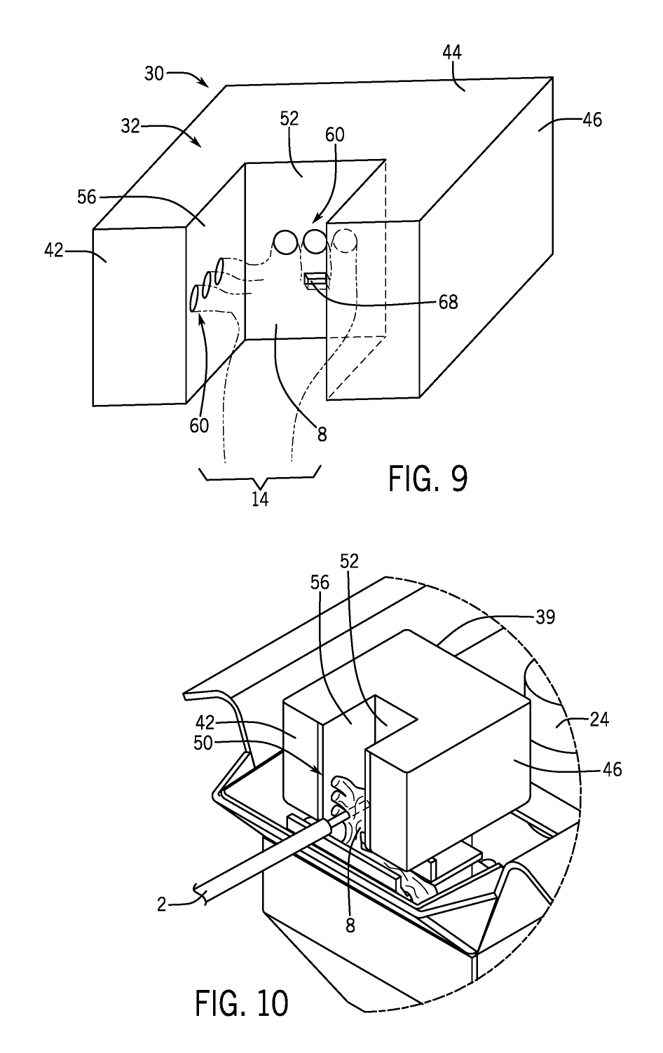

It should be recognized that the holes 60 may also be configured to dispense liquid solder 6 in a direction that is not purely horizontal, including a slightly upward or downward direction, and/or inwardly or outwardly from the nozzle reservoir 32. One example of such a configuration is shown for the nozzle 30 of FIG. 9, which includes an upwardly directed hole 68 defined in the recessed front face 52 within the soldering region 50. Based on the geometry of the upwardly directed hole 68 defined within the recessed front face 52, the liquid solder 6 is dispensed in an upward and horizontal direction (via head pressure HP and/or additional pumping pressure, as discussed above).

FIG. 9 also demonstrates a configuration of nozzle 30 having holes 60 that are defined in only one of the internal side faces 56, but also defined in the recessed front face 52. In further embodiments, additional holes 60 are also defined in the other side of the internal side faces 56, as well as the holes 60 being in different locations within each face.

It should be further noted that the holes 60 in different embodiments vary in size and quantity, as well as being different shapes, to optimize the flow rate and pattern of the liquid solder 6 dispensed from the nozzle 30 and the combined stream 8 formed where liquid solder 6 streams are merged. Moreover, in certain embodiments, the holes 60 are not all identical to each other, such as providing a larger hole in a lower position (such as the upwardly directed hole 68 of FIG. 9) to address the challenge of coating the underside of the wire 2. In other embodiments, the holes 60 in lower positions are designed to be smaller such that liquid solder 6 being dispensed therefrom has a greater pressure than would be provided with a hole 60 that is larger.

As shown in the embodiments of FIGS. 5-10, the holes 60 may be arranged to be opposing such that the wire 2 is between the opposing sets of holes 60 when the wire 2 is placed within the soldering region 50. However, further embodiments having holes 60 that are non-opposing, including those emanating from a single face, are also anticipated by the present disclosure. For example, in embodiments having holes 60 within a single face (i.e., from the front face 42), the holes 60 may be defined such that liquid solder 6 is discharged non-perpendicularly to the single face. In one embodiment, upper holes 62a and 62b are each defined in the single face such that the corresponding streams of liquid solder 6 merge into a combined stream 8 in front of the single face.

In certain embodiments, the floor 36 is perpendicular to the plurality of walls 40, which together define both a soldering region 50 and a remaining non-soldering region. As shown in the embodiment of FIG. 6, the non-soldering region includes a front face 42, a rear face 44 that is opposite the front face 42, and external side faces 46 that couple the front face 42 and the rear face 44. Although the rear face 44 and external side faces 46 are shown as flat, plate-like members, the rear face 44 could be curved and the side faces 46 curved or angled in alternate embodiments. In certain embodiments, the soldering region 50 is recessed into the nozzle reservoir 32 and includes internal side faces 56 that are perpendicular to the front face 42. In such an arrangement, the holes 60 are defined within the internal side faces 56, which may be defined opposingly within two or more walls, such as the internal side faces 56 previously discussed. In certain embodiments, a recessed front face 52 between the internal side faces 56 is parallel to the front face 42. The recessed front face 52 may also, or alternatively, define a portion or all of the holes 60.

FIGS. 7 and 8 depict the insertion of a wire 2 to be soldered within the presently disclosed solder application system 1. As shown, some of the holes 60, designated as upper holes 62a and 62b, are shown to be above other holes 60, which are designated as lower holes 66a and 66b. In certain embodiments, middle holes 64a and 64b are also be defined between the upper holes 62a and 62b and lower holes 66a and 66b. In the embodiment shown, a middle hole 64a, 64b is defined within each of the two internal side faces 56.

Additional sets of middles holes, and differing numbers and locations of upper holes, middle holes, and/or lower holes, are also anticipated by the present disclosure. As examples, the holes 60 may exclusively include upper holes 62a and 62b that are defined in opposite sides of the internal side faces 56, or the holes 60 may include only an upper hole 62b, middle holes 64a and 64b, and a lower hole 66b.

FIG. 8 shows the liquid solder 6 being dispensed from the upper holes 62a and 62b defined in the internal side faces 56 and merging to form a combined stream 8, the combined stream 8 thereby covering all sides of the wire 2. Based on the position of the wire 2 relative to the holes 60, the upper holes 62a and 62b largely direct the liquid solder 6 towards the top of the wire 2. In contrast, the middle holes 64a and 64b are positioned below the top of the wire 2, directing the liquid solder 6 towards the sides of the wire 2 in a substantially horizontal manner. Additionally, some portion of the liquid solder 6 dispensed from the middle holes 64a and 64b is directed across the underside of the wire 2, once again following a path that at least includes a horizontal component. The lower holes 66a and 66b in the present configuration are positioned substantially near the underside of the wire 2 such that a portion of the liquid solder 6 is dispensed on the sides of the wire 2, but another portion is dispensed towards the underside of the wire 2. Based on the these orientations for dispensing the liquid solder 6, along with the increased turbulence of the combined stream 8 from combining the separate streams of liquid solder 6, the present inventors have identified that the wire 2 is consistently and completely soldered on all sides, as well as throughout the wire in the case of stranded wire configurations.

The present disclosure further relates to a method for making a nozzle 30 for soldering a workpiece, such as a wire 2, using a solder application system 1. With reference to the exemplary devices and systems shown in FIGS. 5-10, certain embodiments of the method include arranging a plurality of walls 40 to define a nozzle reservoir 32 for containing liquid solder 6 from the solder application system 1. The plurality of walls 40 also define a soldering region 50 that is external to the nozzle reservoir 32. In some embodiments, the soldering region 50 is configured to receive the workpiece therein, though other configurations are also anticipated by the present disclosure. The method further includes defining holes 60 within the plurality of walls 40 in the soldering region 50, whereby the holes 60 are configured to dispense the liquid solder 6 from the nozzle reservoir 32. In this manner, the dispensed liquid solder 6 merges into a combined stream 8 and the workpiece is soldered when placed within the combined stream 8. In further embodiments, the holes 60 are configured to dispense the liquid solder 6 horizontally based on head pressure HP created within the nozzle reservoir 32 from filling the nozzle reservoir 32 with liquid solder 6 to a fill height 34 that is higher than the holes 60. However, as previously described, further embodiments use the pumping system 20 that fills the nozzle reservoir 32, or another pump, to supplement or replace the head pressure HP provided by gravity to force the liquid solder 6 out from the nozzle reservoir 32 through the holes 60 in the soldering region 50.

In certain embodiments, the holes 60 are arranged to be opposing such the workpiece is positioned between the opposing holes when placed within the soldering region 50. As shown in FIG. 5-10, the holes 60 in certain embodiments are arranged as two columns of three rows of holes 60. In such a configuration, the liquid solder 6 is dispensed from each of the streams from the holes 60 to be parallel to the streams from the other holes 60.

The present disclosure further relates to a solder application system 1 for soldering a workpiece, such as a wire 2. The solder application system 1 includes a solder pot 10 for containing liquid solder 6 and a nozzle 30 configured to dispense the liquid solder 6 for soldering the workpiece. The nozzle 30 includes a plurality of walls 40 and a floor 36 that together define a nozzle reservoir 32 for containing the liquid solder 6 to be dispensed. The plurality of walls 40 further define a soldering region 50 that is external to the nozzle reservoir 32. The plurality of walls 40 within the soldering region 50 define holes 60 that are configured to dispense the liquid solder 6 from the nozzle reservoir 32. The solder application system 1 further includes a pumping system 20 for pumping the liquid solder 6 from the solder pot 10 to the nozzle reservoir 32 in the conventional manner known in the art. However, the holes 60 of the presently disclosed solder application system 1 are uniquely configured such that the liquid solder 6 dispensed from the holes 60 merges into a combined stream 8. In this regard, placing the workpiece within the combined stream causes the workpiece to be soldered.

Through experimentation and development, the present inventors have identified that the systems, devices, and methods disclosed herein provide for consistent and complete soldering of a workpiece, including a wire 2, which is in contrast to systems, devices, and methods commonly known in the art.

In the above description, certain terms have been used for brevity, clarity, and understanding. No unnecessary limitations are to be inferred therefrom beyond the requirement of the prior art because such terms are used for descriptive purposes and are intended to be broadly construed. The different assemblies described herein may be used alone or in combination with other devices. It is to be expected that various equivalents, alternatives and modifications are possible within the scope of any appended claims.

1. A nozzle for soldering a workpiece using a solder application system, the nozzle comprising:
a plurality of walls and a floor that together define a nozzle reservoir for containing liquid solder filled up to a fill height therein, wherein the plurality of walls also define a soldering region that is external to the nozzle reservoir, wherein the plurality of walls in the soldering region define a plurality of holes that are each defined below the fill height and each configured to dispense a stream of the liquid solder from the nozzle reservoir;
wherein when the liquid solder is filled up to at least the fill height, a head pressure is generated at each of the plurality of holes such that the stream of the liquid solder is dispensed therefrom; and
wherein the nozzle is configured such that the workpiece is soldered when placed into the soldering region.

2. The nozzle according to claim 1, wherein the plurality of holes are defined such that the streams of the liquid solder dispensed therefrom merge into a combined stream, and wherein the workpiece is soldered when placed into the combined stream.

3. (canceled)

4. The nozzle according to claim 2, wherein the liquid solder is dispensed based only on head pressure caused by the fill height being higher than the plurality of holes.

5. The nozzle according to claim 2, wherein the plurality of holes include at least two opposing holes, and wherein the at least two opposing holes are configured such that the workpiece is between the at least two opposing holes when the workpiece is placed in the soldering region.

6. The nozzle according to claim 5, wherein the plurality of holes comprises upper holes and lower holes, wherein the upper holes are higher than the lower holes.

7. The nozzle according to claim 5, wherein the streams of the liquid solder dispensed from the at least two opposing holes are parallel to each other when exiting the at least two opposing holes.

8. The nozzle according to claim 1, wherein the soldering region is recessed into the nozzle reservoir from a front face and is configured to receive the workplace therein.

9. The nozzle according to claim 1, wherein the floor is perpendicular to the plurality of walls.

10. The nozzle according to claim 1, wherein the plurality of walls defines a non-soldering region that include a front face, a rear face that is opposite the front face, and external side faces that couple the front face and the rear face;
wherein the soldering region includes internal side faces that are perpendicular to the front face; and
wherein the holes are defined within the internal side faces.

11. A method for making a nozzle for soldering a workpiece using a solder application system, the method comprising:
arranging a plurality of walls and a floor to together define a nozzle reservoir for containing liquid solder from the solder application system, wherein the plurality of walls define a soldering region that is external to the nozzle reservoir and is configured to receive the workpiece; and
defining a plurality of holes within the plurality of walls in the soldering region, wherein the plurality of holes are configured to dispense the liquid solder from the nozzle reservoir, wherein the nozzle is configured such that the workpiece is soldered when placed in the soldering region.

12. The method according to claim 11, wherein the plurality of holes include at least two opposing holes that each dispense a flow of solder having a horizontal flow direction such that the dispensed liquid solder flows merge into a combined stream, wherein the nozzle is configured such that the workpiece is soldered when placed into the combined stream.

13. The method according to claim 12, wherein the nozzle reservoir is configured to be filled with liquid solder to a fill height, and wherein the fill height is higher than the plurality of holes.

14. The method according to claim 13, further comprising configuring the nozzle such that the liquid solder is dispensed based only on head pressure from the fill height being higher than the plurality of holes.

15. The method according to claim 11, wherein the plurality of holes include at least two pairs of opposing holes, and wherein the at least two pairs of opposing holes are configured such that the workpiece is between the at least two pairs of opposing holes when the workpiece is placed in the soldering region.

16. The method according to claim 15, wherein the opposing holes are arranged as two columns of three rows of individual holes.

17. The method according to claim 15, wherein the opposing holes are configured such that the flow of liquid solder dispensed from the opposing holes is parallel for each of the opposing holes.

18. A solder application system for soldering a workpiece, the solder application system comprising:
a solder pot for containing liquid solder;
a nozzle configured to be filled up to a fill height with the liquid solder and to dispense the liquid solder for soldering the workpiece, wherein the nozzle comprises a plurality of walls and a floor, wherein the plurality of walls define a soldering region, and wherein the plurality of walls within the soldering region include a plurality of holes each defined below the fill height and each configured to dispense a flow of the liquid solder from the nozzle reservoir in a horizontal direction; and
a pumping system for pumping the liquid solder from the solder pot to the nozzle;
wherein when the liquid solder is filled up to at least the fill height, a head pressure is generated at each of the plurality of holes such that the stream of the liquid solder is dispensed therefrom; and
wherein the plurality of holes are positioned such that the flow of the liquid solder dispensed therefrom merges into a combined stream in the soldering region such that the workpiece is soldered when placed into the combined stream.

19. The solder pot according to claim 18, further comprising a nozzle reservoir for containing the liquid solder to be dispensed;
wherein the floor is perpendicular to the plurality of walls;
wherein the plurality of walls defines a non-soldering region that include a front face, a rear face that is opposite the front face, and external side faces that couple the front face and the rear face;
wherein the soldering region includes internal side faces that are perpendicular to the front face; and
wherein the plurality of holes are located within the internal side faces.

20. The solder pot according to claim 18, wherein the plurality of holes include at least two pairs of opposing holes that are configured such that the workpiece is between the at least two pairs of opposing holes when the workpiece is placed in the soldering region;
wherein the at least two pairs of opposing holes comprise upper opposing holes and lower opposing holes that are lower than the upper opposing holes; and
wherein the liquid solder dispensed from the upper opposing holes are parallel to each other.
